(19) United States
(12) Patent Application Publication
(10) Pub. No.: US 2020/0255277 A1
(43) Pub. Date: Aug. 13, 2020

(54) BEVERAGE DISPENSER WITH CONSUMER DEMOGRAPHIC IDENTIFICATION SYSTEM

(71) Applicant: The Coca-Cola Company, Atlanta, GA (US)

(72) Inventors: Thomas STUBBS, Atlanta, GA (US); Laura Cline HALL, Smyrna, GA (US)

(21) Appl. No.: 16/641,731

(22) PCT Filed: Aug. 27, 2018
(86) PCT No.: PCT/US2018/048107

§ 371 Date: Feb. 25, 2020

Related U.S. Application Data
(60) Provisional application No. 62/550,788, filed on Aug. 28, 2017.
(60) Provisional application No. 62/582,465, filed on Nov. 7, 2017.

(51) Int. Cl. B67D 1/08; G07F 13/06; G06K 9/00

(52) U.S. Cl. CPC B67D 1/0888; B67D 1/0041; G06K 9/00288; G07F 13/065

(57) ABSTRACT

The present application provides a beverage dispenser for dispensing a number of different beverages to a consumer. The beverage dispenser may include a graphical user interface for the consumer to make a beverage selection, a nozzle to dispense the beverage selection, and a consumer demographic identification system to determine one or more demographic characteristics of the consumer without individually identifying the consumer.

### TECHNICAL FIELD

The present application and the resultant patent relate generally to a beverage dispenser and more particularly relate to a beverage dispenser with consumer demographic identification system to recognize one or more demographic characteristics of a consumer.

### BACKGROUND OF THE INVENTION

Current beverage dispensers generally may record and store data concerning the number and type of beverages or other products dispensed therefrom. For example, this information may be useful in determining when a particular beverage ingredient may be depleted and in need of being replaced. Such information also may be relevant in completing the purchase of a beverage or other product. Although the number and type of beverages dispensed may be known, information on the nature of the consumer for any particular dispense may not be readily available. In other words, the demographic characteristics of a consumer of a particular beverage brand, flavor, and the like may be useful for marketing purposes as well as for an improved consumer experience. To date, such data may be obtained, for example, through loyalty programs or focus groups. In loyalty programs, demographic data may be obtained only for those consumers who join the program. Focus groups also may generate such demographic data but at great expense and generally over an extended period of time. Dynamic, real time information is simply not available.

### SUMMARY OF THE INVENTION

The present application and the resultant patent thus provide a beverage dispenser for dispensing a number of different beverages to a consumer. The beverage dispenser may include a graphical user interface for the consumer to make a beverage selection, a nozzle to dispense the beverage selection, and a consumer demographic identification system to determine one or more demographic characteristics of the consumer without individually identifying the consumer.

The present application and the resultant patent further provide a method of operating a beverage dispenser providing a number of different beverages to a consumer. The method may include the steps of sensing physical characteristics of the consumer, matching those physical characteristic of the consumer with demographic characteristics, promoting a beverage selection to the consumer based upon the matched demographic characteristics, and providing a beverage to the consumer.

The present application and the resultant patent further provide a beverage dispenser for dispensing a number of different beverages. The beverage dispenser may include a dispensing area to dispense the beverage and a consumer demographic identification system to determine one or more demographic characteristics of a user. The consumer demographic identification system may include one or more sensors and a database.

These and other features and improvements of the present application and the resultant patent will become apparent to one of ordinary skill in the art upon review of the following detailed description when taken in conjunction with the shown drawings and the appended claims.

### BRIEF DESCRIPTION OF THE DRAWINGS

FIG. 1 is a perspective view of an example of a beverage dispenser as may be described herein.

FIG. 2 is a schematic diagram of the control architecture and network connectivity of the beverage dispenser of FIG. 1.

FIG. 3 is a schematic diagram of an order record that may be used in the beverage dispenser of FIG. 1.

FIG. 4 is a flow chart showing exemplary method steps in the operation of the beverage dispenser of FIG. 1.

FIG. 5 is a schematic diagram of a pour control system that may be used with the beverage dispenser of FIG. 1.

FIG. 6 is flow chart showing exemplary method steps in the operation of the pour control system of FIG. 5.

FIG. 7 is a schematic diagram of a crew access system that may be used with the beverage dispenser of FIG. 1.

FIG. 8 is a flow chart showing exemplary method steps in the operation of the crew access system of FIG. 7.

FIG. 9 is a schematic diagram of a consumer reward system that may be used with the beverage dispenser of FIG. 1

FIG. 10 is a flow chart showing exemplary method steps in the operation of the consumer reward system of FIG. 9.

### DETAILED DESCRIPTION

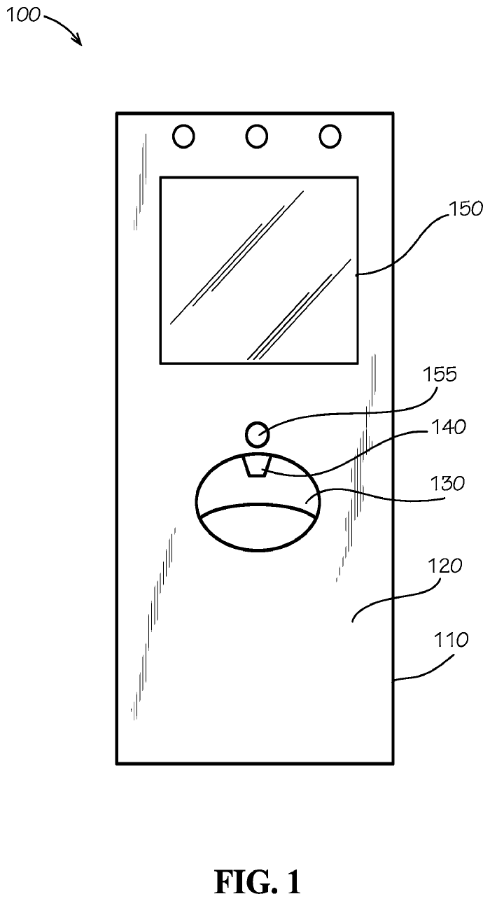

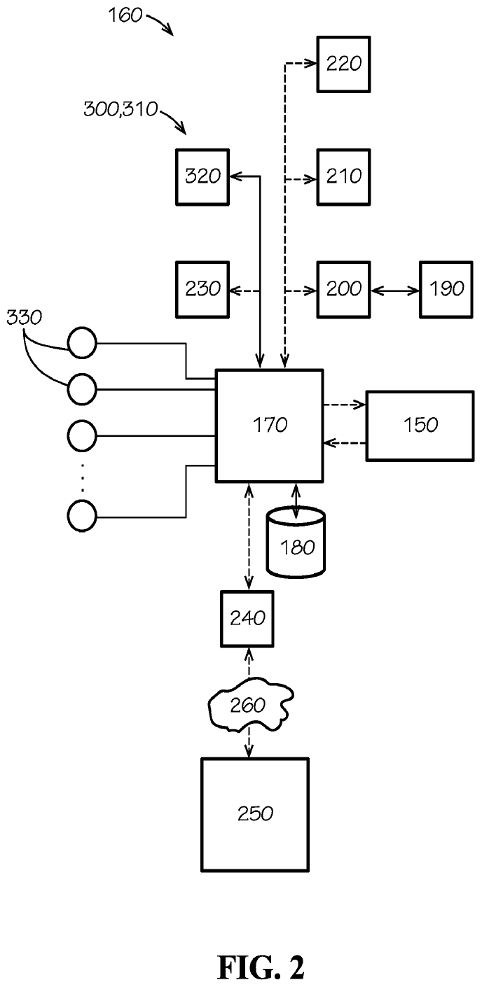

Referring now to the drawings, in which like numerals refer to like elements throughout the several views, FIG. 1 and FIG. 2 show an example of a beverage dispenser 100 as may be described herein. The beverage dispenser 100 may dispense many different types of beverages, other types of fluids, and/or other types of products. An example of the beverage dispenser 100 is the “COCA-COLA FREESTYLE®” refrigerated beverage dispensing unit offered by The Coca-Cola Company of Atlanta, Ga. Generally described, the “COCA-COLA FREESTYLE®” refrigerated beverage dispensing unit creates a beverage by combining a number of highly concentrated micro-ingredients with a macro-ingredient such as a sweetener and a diluent. The micro-ingredients generally are stored in cartridges positioned within the beverage dispenser itself. The number and type of beverages offered by the beverage dispenser 100 thus may be limited only by the number and type of micro-ingredient cartridges positioned therein. Alternatively, convention bag-in-box based beverage dispensers and the like also may be used herein.

The beverage dispenser 100 may include an outer shell 110 with an access door 120. The micro-ingredient cartridges and other types of beverage ingredients may be loaded through the access door. The outer shell 110 may define a dispensing area 130 with one or more dispensing nozzles 140. The beverage dispenser 100, and the components thereof, may have any suitable size, shape, or configuration.

The beverage dispenser 100 may include a graphical user interface 150 positioned thereon. The graphical user interface 150 may include a video screen and the like so as to allow a consumer to select any number of different beverage or product brands, types, and/or formulations. The graphical user interface 150 may present the consumer with a series of dynamically generated menus and/or static menus. Selecting a menu item may cause the beverage dispenser 100 to formulate and dispense the beverage. The graphical user interface 150 also may display any type of graphics, messaging, video, and the like. Sound also may be incorporated herein. One or more separate display screens, banner screens, and the like also may be used. Different types of mechanical and/or electro-mechanical push buttons, such as a pour button 155, also may be used. Other components and other configurations also may be used herein.

FIG. 2 shows an example of the control architecture 160 of the beverage dispenser 100. The control architecture 160 may include a controller or a processor 170 coupled to a database 180 or other type of memory. The processor 170 may be any type of programmable logic device. The processor 170 may be local or remote. Multiple processors 170 may be used herein. The processor 170 may execute computer-executable program instructions stored in the database 180. The computer executable program instructions may include any number of module application programs required to operate the beverage dispenser 100. Specifically, the database 180 may include at least one of code instructions, information structures, or the like. Such instructions and information structures may embody or constitute machine-learning techniques (e.g., pattern recognition algorithms; inference algorithms; triangulation or location estimation algorithms; temporal algorithms; and the like) that may be utilized to implement the functionality described herein. The database 180 also may store information such as beverage recipes, ingredient volumes used, ingredient volumes remaining, transactional information, and the like.

The processor 170 also may be in communication with the graphical user interface 150 so as to receive consumer orders and/or otherwise communicate with the consumer. Any number of application modules and controls may be used herein. For example, the processor 170 may be in communication with a number of pumps and valves 190 via a pump control module 200 so as to dispense a beverage selected on the graphical user interface 150 based on a recipe stored in the database 180. Video, audio, and other content may be driven to the graphical user interface 150 via a video driver 210 and an audio driver 220. The overall lighting may be operated via a lighting module 230. Many other types of controls and functionality may be used herein.

The processor 170 also may be in communication with a network interface 240. The network interface 240 may be in communication with one or more remote servers 250 or other types of computational/storage devices over a network 260. Any or all of the functionality of the beverage dispenser 100 may be provided remotely. The network 260 may include any one or a combination of multiple different types of networks, such as cable networks, the Internet, wireless networks, and other types of private or public networks. In this manner, the beverage dispenser 100 may access, receive from, transmit to, or otherwise interact with the servers 250 or elsewhere. The beverage dispenser 100 may be in communication with other beverage dispensers, other computers or servers, original equipment manufacturers, third party vendors, and the like over the network 260. The beverage dispenser 100 may be in communication with any number of devices over the network 260.

The beverage dispenser 100 may include a consumer demographic identification system 300. The consumer demographic identification system 300 may determine any number of demographic characteristics of a consumer based on the consumer's physical or other characteristics while dispensing a beverage or other product. The consumer demographic identification system 300 may determine such demographic characteristics of a consumer related to the beverage being dispensed without the need to individually identify the consumer and/or store any images or other types of data that could individually identify the consumer. Rather, the objective herein is to tie the beverage being dispensed to as many demographic characteristics of the consumer as possible. In this context, the individual identity of the consumer is not required or even particularly helpful.

The consumer demographic identification system 300 may include a characteristic recognition system 310. The characteristic recognition system 310 may include a conventional facial recognition system and the like. Example of known facial recognition systems may be provided by IBM, Google, Amazon, Microsoft, and others. Generally described, the characteristic recognition system 310 may include a facial recognition module 320 in communication with the processor 170 and one or more sensors 330 positioned about the outer shell 110 of the beverage dispenser 100 or elsewhere. The sensors 330 may include cameras, optical sensors, RADAR (Radio Detection and Ranging), LIDAR (Light Detection and Ranging), SONAR (Sound Navigation and Ranging), IR (Infrared), NIR (Near Infrared), RF (Radiofrequency), or other types of sensor technology. Combinations of different sensors 330 may be used herein. Other components and other configurations may be used herein.

The characteristic recognition system 310 may determine demographic characteristics of the consumer based upon data obtained from the sensors 330. The data may be processed via recognition algorithms in the facial recognition module 320 and compared to known demographic characteristics developed in the database 180 via machine learning techniques. The facial recognition module 320 and/or the database 180 may be local or remote. The facial recognition algorithms may identify facial features of a consumer such as the relative position, shape, and/or size of the eyes, nose, cheekbones, and jaw and use the data related to these feature to search for matching demographic characteristics. The use of multiple sensors 330 may provide for increased accuracy through three-dimensional modeling. Known facial recognition algorithms include principal component analysis using eigenfaces, linear discriminant analysis, elastic bunch graph matching using the Fisherface algorithm, the hidden Markov model, the multilinear subspace learning using tensor representation, the neuronal motivated dynamic link matching, and similar algorithms. Other components and other configurations may be used herein.

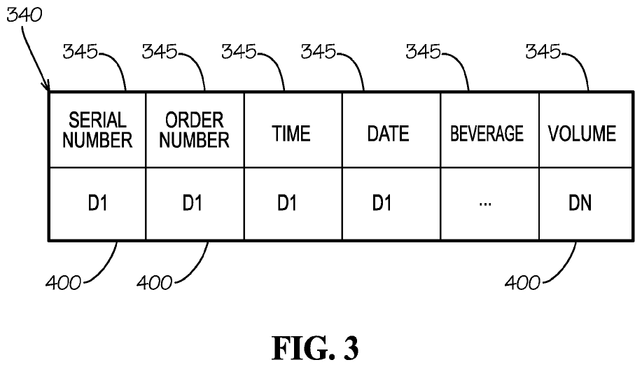

Examples of consumer demographic characteristics may include height, age, sex, nature of clothing, indicia on clothing, and even current sentiment. Many other types of characteristics may be captured herein. The sensors 330 also may determine the number of other consumers in the vicinity, consumer wait times, the nature of the food or other items purchased, and the like. This information may be combined with local information such as location, date, time, weather, local events, and the like. FIG. 3 shows an example of an order record 340 as may be used herein. The order record 340 may include a dispenser serial number 345, an order number 350 or other identifier, date 360, time 370, beverage type 380, volume 390, and any number of other types of demographic keys 400. The use of the dispenser serial number 345 with the other data thus ties the other data to that dispenser. Other types of transaction data and other types of information also may be stored on the order record 340. The order record 340 with the demographic keys 400 may be stored in the database 180 or elsewhere. Order records 340 from other beverage dispensers 100 may be combined in a central database and the like so as to improve the accuracy of the overall consumer demographic identification system 300 via machine learning techniques and the like.

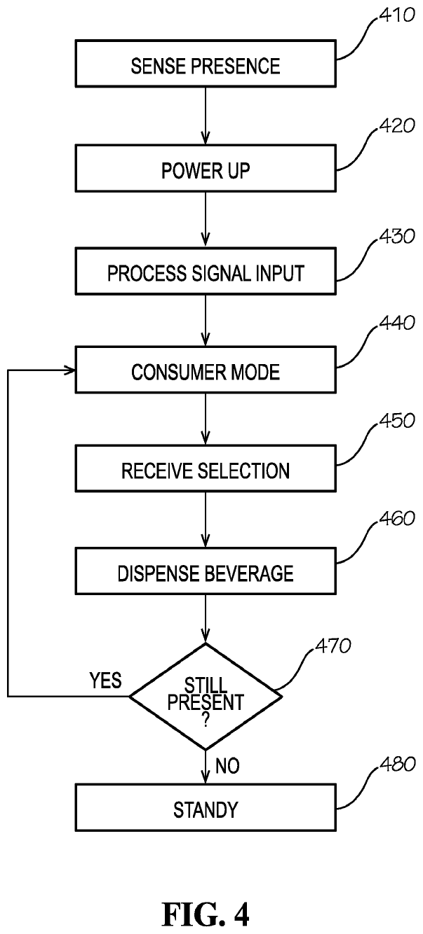

FIG. 4 shows a flow chart with exemplary steps in the operation of the beverage dispenser 100 with the consumer demographic identification system 300. At step 410, the sensors 330 of the characteristic recognition system 310 may detect the presence of an individual in the vicinity of the beverage dispenser 100. At step 420, the processor 170 thus may power up the beverage dispenser 100 from a standby mode or other type of dormant mode. At step 430, the processor 170 and the facial recognition module 320 may begin processing data received from the sensors 330. At step 440, the processor 170 may switch the beverage dispenser 100 into consumer mode as may be described in more detail below. At step 450, the processor 170 may check if a selection has been received on the graphical user interface 150. If so, at step 460 the processor 170 may dispense a beverage. At step 470, the processor 170 may check if a consumer is still present in the vicinity of the beverage dispenser 100. If so, the processor 170 may maintain the beverage dispenser 100 in the consumer mode. If not, the processor 170 may maintain the beverage dispenser 100 in consumer mode for a predetermined amount of time until, at step 480, the processor 170 puts the beverage dispenser 100 in standby mode or other type of dormant mode. The method steps described herein are for the purpose of example only. Many other and different method steps may be used herein in any order or combination.

In the consumer mode, the consumer demographic identification system 300 may present different type of images or promotions depending upon the age, gender, and emotion of the consumer as well as what the consumer is wearing, the weather, and/or other factors or characteristics. For example, if the consumer demographic identification system 300 determines that the consumer is a college age male, the beverage dispenser 100 may promote a COKE ZERO™ brand beverage from the Coca-Cola Company of Atlanta, Ga. or other type of beverage popular with that particular demographic. If the consumer demographic identification system 300 determines that the consumer is wearing work out clothing, the beverage dispenser 100 may promote a sports beverage on the graphical user interface 150. If the consumer demographic identification system 300 determines that the consumer is wearing a shirt with the name of a local sports team, the beverage dispenser 100 may display a current game score on the graphical user interface 150. If the consumer demographic identification system 300 determines that the consumer is under a predetermined height or in a wheel chair, the beverage dispenser 170 may position the menu choices on a lower part of the graphical user interface 150. The data related to consumer and the subsequent choices/actions of the consumer may be interpreted to determine whether suggestions for beverages are selected more often than other beverage choices. Many other types of data analytics use cases may be implemented herein.

In another example, the consumer demographic identification system 300 may determine the number and/or types of consumers waiting to be served, the weather, local events, and the like so as to determine patterns between consumers and various circumstances. For example, if a number of consumers wait for their beverage for more than a predetermined interval, then the menu options on the graphical user interface 150 may be reduced. A determination that a further beverage dispenser may be needed also may be made. On days with local sports events, there may be more beverages dispensed than usual such that amount of inventory on hand may be revised.

The consumer demographic identification system 300 also may be able to determine the sentiment of the consumer. For example, whether a consumer who appears angry seems to appear happier after dispensing a beverage and/or whether the consumer enjoyed the beverage. Such data also may be used to identify new mixes that are preferred by consumers and post “what's trending” mixes on the beverage dispenser 100 and/or share to social media. Entirely new beverage combinations thus may be created and promoted.

In another example, the consumer demographic identification system 300 may provide a recommendation to a consumer based on biometric data such as data from the consumer's wearable fitness device, fingerprint, or IR image. For example, the consumer demographic identification system 300 may recommend a hydration beverage if the consumer has taken a certain number of steps or if the IR image is reading an elevated temperature.

In a further example, the consumer demographic identification system 300 may provide a recommendation to a consumer upon the consumer presenting the food purchased so as to provide a pairing beverage choice. For example, if the consumer demographic identification system 300 determined that a consumer purchased a salad with chicken and fruit the beverage dispenser 100 may recommend a lemonade with strawberry flavor to pair with the salad.

In a further example, the sensors 330 of the consumer demographic identification system 300 may record gesture inputs from a consumer pointing at a menu and selecting items from the menu by recording where in space the consumer is pointing relative to the icons on the menu or screen. The sensors 330 also may be used to record the eye movement of a consumer and analyze the data to determine a better graphical user interface layout, motion, or optimize some other feature of the graphical user interface 150. A radar-based sensor or heat sensor may determine where a consumer is pointing or track the motion of fingertips and use the data to improve the layout of the graphical user interface 150 and/or user experience. For example, if a large number of consumer have to go through a significant number of screens to reach their beverage of choice then based on the first of second screen choice the consumer may be presented with a predicted end screen for final selection, skipping additional screens.

The beverage dispenser 100 with the consumer demographic identification system 300 thus uses demographic data for both immediate individual promotion in the consumer mode and for long-term aggregate use in the context of a specific beverage type. Specifically, the use of the consumer demographic identification system 300 “closes the loop” on beverage pours based on demographic data. The consumer demographic identification system 300 thus ties the number and type of beverage pours to the specific demographics in a real time fashion. Such demographic information may lead to improved marketing both locally at the beverage dispenser itself as well as on a regional, a national, or even a global scale. Improved research and development and may be provided by capturing real time consumer sentiment on tasting any particular beverage.

Local improvements also may be made by decreasing queue time though modifications to the graphical user interface 150 based upon volume. Specific information as customer to purchase ratio in any given location also may be provided by comparing the number of consumers using the beverage dispenser 100 to the total number of consumers about the beverage dispenser 100. By tailoring the graphical user interface 150 to the demographics of the consumer, the consumer's overall use experience may be improved. Finally, by relying on the sensors 330 to determine when consumers may be present, the overall energy use of the beverage dispenser 100 may be reduced.

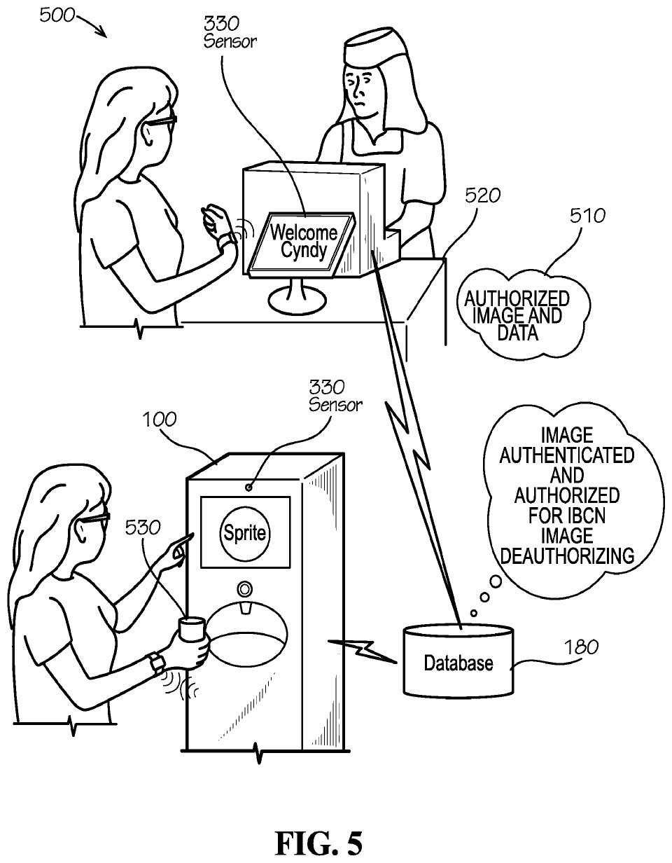

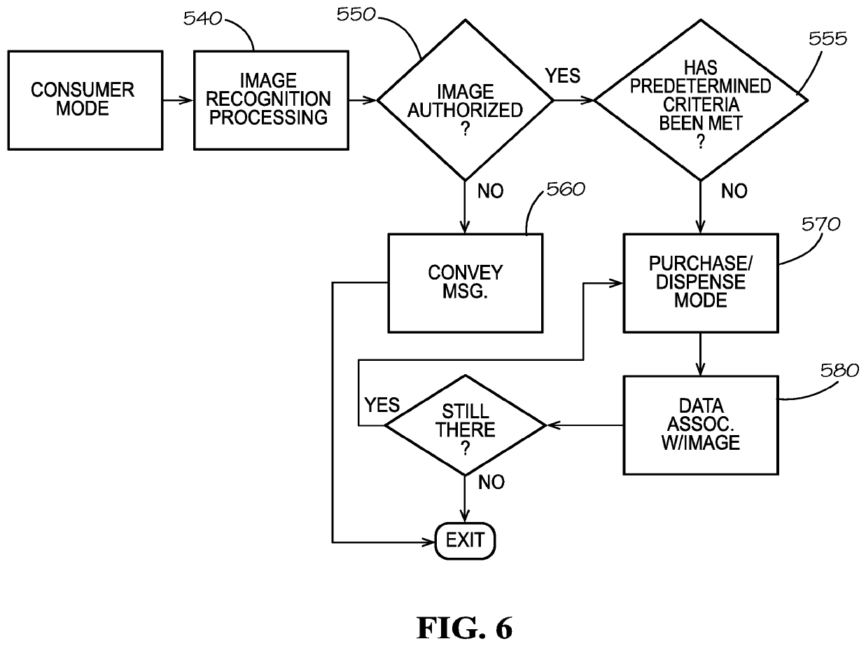

In varying circumstances, certain types of identifying information may be obtained and used either locally or on a larger scale. For example, a retail outlet may desire and/or be required to limit access to access to the beverage dispenser 100. FIGS. 5 and 6 show the use of a pour control system 500. Data captured by the characteristic recognition system 310 of the consumer demographic identification system 300 may be used to create a unique, anonymous identifier 510 that provides controlled access to the beverage dispenser 100. The unique identifier 510 may only confirm the appearance of a consumer. The unique identifier 510 may be used in a specific location such as the retail outlet and may expire after a predetermined amount of time. The unique identifier 510 also may contain information such as cup size and the like.

The consumer demographic identification system 300 may generate the unique identifier 510 at, for example, a point of purchase 520. The unique identifier 510 may include, for example, time, available volume verses poured volume, available time verses start time and finish time, available calories versus poured calories, and other parameters. The consumer may be given a cup 530 to be filled with a beverage at one or more beverage dispensers 100. The sensors 330 on the beverage dispensers 100 may capture data when the consumer approaches to determine if the unique identifier 510 is matched. The sensors 330 also may detect and identify the cup 530. Specifically, at step 540 characteristic recognition may begin. The pour control system 500 may determine if the consumer is identified at step 550 and authorized at step 555. If not, the consumer is notified at step 560. If so, at step 570 the beverage dispenser 100 enters dispense mode under a number of different dispense limitations or parameters. At step 580, dispense data associated with the image may be updated. Other and different method steps may be used herein.

Various types of dispense limitations or parameters may be applied. For example, free refills may be prevented. To the extent that available volume, time, calories, refills are not completed or expired, the consumer will be allowed further dispensing. The paid for total volume, however, may not be exceeded. Other limitations may include the prevention of an authorized consumer sharing an authorized cup 530 with an unauthorized consumer, prevention of reusing an authorized cup 530 on a different day, and use by unauthorized consumers. Other types of business parameters may be applied herein. The pour control system 500 thus provides accurate dispensing control across a large number of access parameters.

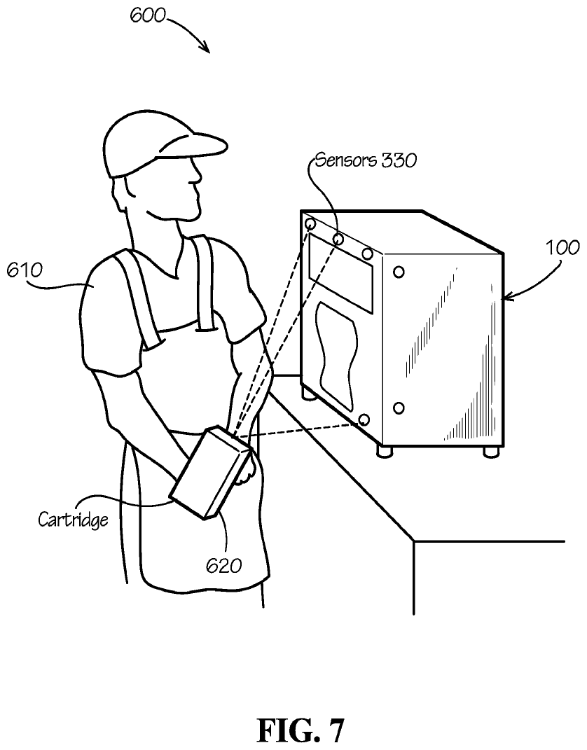

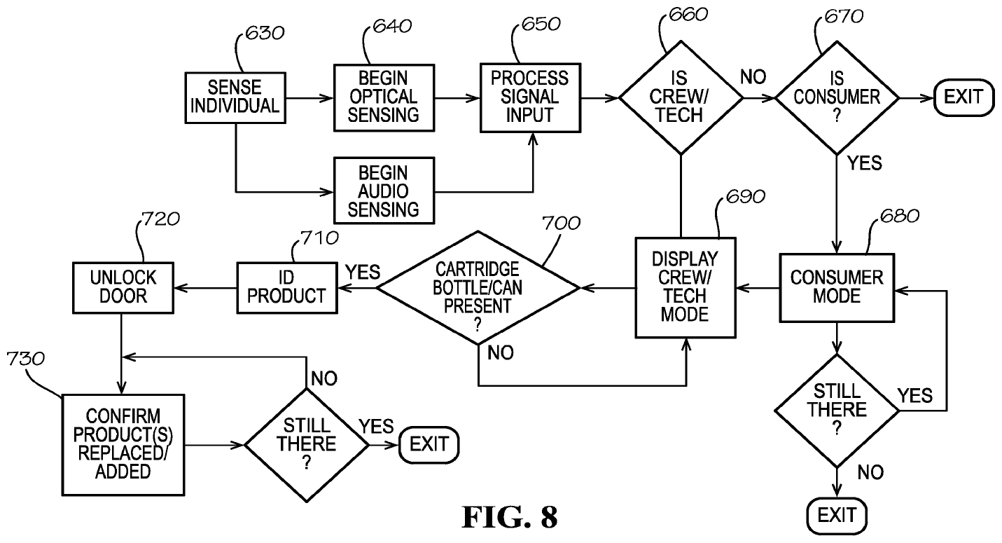

In other situation, the consumer demographic identification system 300 may identify a consumer or other type of person by name or other type of identifier and store that information. For example, FIGS. 7 and 8 show an example of a crew access system 600. The consumer demographic identification system 300 may identify each crew member 610 needing access to the beverage dispenser 100 and store that information, either locally or on some other scale. When the crew member 610 approaches the beverage dispenser 100, the sensor 330 may begin characteristic recognition. The sensors 330 also may recognize, for example, an ingredient cartridge 620 or other type of ingredient container that the crew member 610 may have with him or her.

Specifically, the beverage dispenser 100 may sense the presence of an individual at step 630. At step 640, the consumer demographic identification system 330 may begin sensing with the sensors 330 and may process that data at step 650. At step 660, the database 180 may be check to see if the individual is a crew member 610. If not, the consumer demographic identification system 300 checks if the individual is a consumer at step 670 and, if so, enters consumer mode at step 680. If so, the beverage dispenser 100 may enter crew mode at step 690. If the sensors 330 detect a cartridge 620 and the like at step 700 and identify the cartridge 620 at step 710, the beverage dispenser 100 may unlock the door 120 to allow access to the crew member 610 at step 720. At step 730, the beverage dispenser 100 may check that the correct cartridge 620 and the like has been inserted. Other and different method steps may be used herein. The crew access system 600 thus provides access to authorized crew members 610 as well as the use of authorized cartridges 620 and the like.

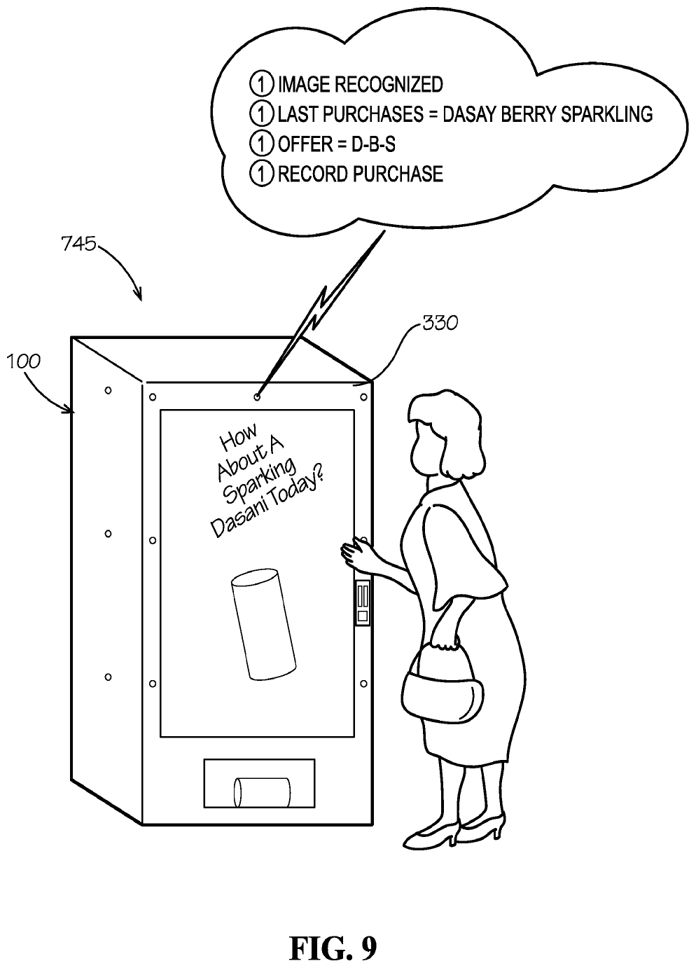

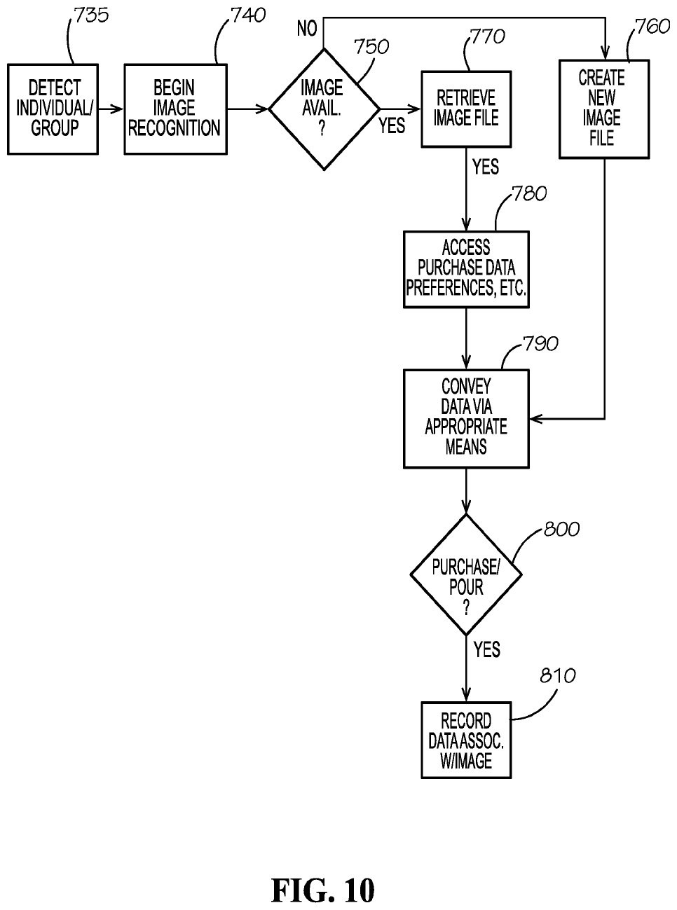

The consumer demographic identification system 300 also may make and/or store limited identification of certain consumers. FIGS. 9 and 10 show a consumer loyalty system 745 as may be described herein. For example, certain consumers may join a loyalty plan and the like and/or otherwise opt in to provide identification. The consumer demographic identification system 300 thus may identify the consumer (anonymously or not) along with the consumer's preferences and other information such as purchases. The consumer loyalty system 745 thus may use that information to suggest beverages types to the consumer, offer rewards to the consumer for frequent purchases, or otherwise communicate with the consumer.

In use, the sensors 330 of the consumer demographic identification system 300 may detect the presence of an individual at step 735 and begin image recognition at step 740. At step 750, the consumer demographic identification system 300 may determine if the consumer's image is available and authorized. If not, the consumer demographic identification system 300 may ask the consumer if an identifiable image may be created at step 760. If the image is available, the consumer demographic identification system 300 may retrieve the image file at step 770 and access consumer information and/or preferences at step 780. At step 790, the consumer loyalty system 745 may convey that information to the consumer in an appropriate fashion. For example, if the consumer's last purchase was a sparkling water brand, the beverage dispenser 100 may suggest a similar product to the consumer. Alternatively, if the consumer has recently purchased a predetermined number of beverages, the consumer loyalty system 745 may offer the consumer a free beverage and the like. At step 800, the consumer may purchase a beverage or other product. At step 810, the purchase or dispense data, i.e., the consumer's loyalty data, may be recorded with the image. Other and different method steps may be used herein.

The consumer loyalty system 745 thus may identify the consumer so as to reward the consumer along any number of business parameters. Other types of consumer communication and interaction also may be provided herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof

We claim:

1. A beverage dispenser for dispensing a number of different beverages to a consumer, comprising:
a graphical user interface for the consumer to make a beverage selection;
a nozzle to dispense the beverage selection; and
a consumer demographic identification system to determine one or more demographic characteristics of the consumer without individually identifying the consumer.

2. The beverage dispenser of claim 1, wherein the consumer demographic identification system comprises a characteristic recognition system.

3. The beverage dispenser of claim 2, wherein the characteristic recognition system comprises one or more sensors.

4. The beverage dispenser of claim 3, wherein the one or more sensors comprise one or more cameras.

5. The beverage dispenser of claim 3, wherein the one or more sensors comprise a plurality of cameras.

6. The beverage dispenser of claim 3, wherein the one or more sensors comprise cameras, optical sensors, RADAR (Radio Detection and Ranging), LIDAR (Light Detection and Ranging), SONAR (Sound Navigation and Ranging), IR (Infrared), NIR (Near Infrared), or RF (Radiofrequency).

7. The beverage dispenser of claim 2, wherein the characteristic recognition system comprises a facial recognition module in communication with a database.

8. The beverage dispenser of claim 7, wherein the one or more demographic characteristics of the consumer are entered in an order record stored in the database.

9. The beverage dispenser of claim 8, wherein the beverage selection is entered in the order record stored in the database.

10. The beverage dispenser of claim 2, wherein the characteristic recognition system comprises one or more facial recognition algorithms.

11. The beverage dispenser of claim 1, wherein the beverage dispenser comprises a processor and a network connection.

12. The beverage dispenser of claim 11, wherein beverage dispenser is in communication with a network via the network connection.

13. The beverage dispenser of claim 11, wherein the processor applies machine-learning techniques.

14. The beverage dispenser of claim 1, wherein the graphical user interface promotes a beverage selection based on the one or more demographic characteristics of the consumer.

15. A method of operating a beverage dispenser providing a number of different beverages to a consumer, comprising:
sensing physical characteristics of the consumer;
matching those physical characteristic of the consumer with demographic characteristics;
promoting a beverage selection to the consumer based upon the matched demographic characteristics; and
providing a beverage to the consumer.

16. A beverage dispenser for dispensing a number of different beverages, comprising:
a dispensing area to dispense the beverage; and
a consumer demographic identification system to determine one or more demographic characteristics of a user;
the consumer demographic identification system comprises one or more sensors and a database.

17. The beverage dispensing system of claim 16, further comprising a crew access system in communication with the consumer demographic identification system to identify authorized crew members.

18. The beverage dispensing system of claim 16, further comprising a pour control system in communication with the consumer demographic identification system to identify authorized users and authorized dispensing parameters.

19. The beverage dispensing system of claim 16, further comprising a consumer loyalty system in communication with the consumer demographic identification system to identify authorized users and loyalty data an authorized user.

20. The beverage dispensing system of claim 19, wherein the consumer loyalty system provides rewards at the dispenser based on the loyalty data of the authorized user.
